(19) United States
(12) Patent Application Publication
(10) Pub. No.: US 2012/0072181 A1
(43) Pub. Date: Mar. 22, 2012

(54) METHOD AND APPARATUS FOR OPTIMIZING HVAC SYSTEMS IN BUILDINGS

(76) Inventor: Behzad Imani, Hillsborough, CA (US)

(21) Appl. No.: 12/888,277

(22) Filed: Sep. 22, 2010

(51) Int. Cl. G06F 17/50

(52) U.S. Cl. 703/1

(57) ABSTRACT

A computer based method and apparatus for simulating and optimizing design of an HVAC (heating, ventilation, air conditioning system) in a building. Conventional software tools for this purpose use the well known Navier-Stokes partial differential equations used to describe motion of fluid substances by means of computational fluid dynamics using a finite element method to solve the equations and optimize design of building air ducts for carrying warm and cool air through a building. Instead here the HVAC system is initially simulated using an electrical circuit design tool such as SPICE, where room volumes correspond to electrical capacitances, heat sources correspond to electrical resistances, and air flows to electrical currents in a complex R-C electrical circuit. The goal is to improve energy efficiency in terms of the amount of energy used to heat and cool air, and also the amount of energy used to circulate the air through the air ducts.

### FIELD OF THE INVENTION

This disclosure relates to design of heating, ventilation and air-conditioning (HVAC) systems for buildings and especially to computer simulation and models of such systems.

### BACKGROUND

As well known, buildings use a good deal of energy for heating, ventilation and air-conditioning (HVAC). This is true of residences, office buildings, commercial buildings, factories, etc. Building design currently uses what is referred to as computer aided design (CAD) or computer aided engineering (CAE) with special software packages (tools) for various aspects of the building design process. One such software package is “FloVent” supplied by Mentor Graphics. This is a computational fluid dynamics (CFD) software package that predicts airflow in three dimensions, heat transfer, contamination distribution and comfort indices in and around buildings of all types and sizes. It models various aspects of building airflow systems including diffusers, heat exchangers, grills, and enclosures. It uses a Cartesian gridding system and a preconditioned conjugate residual solver using a flexible cycle multi-grid solution. The reference to “grid” here refers to a 3-dimensional model of the building and the air flow in the building. FloVent is typically used to design buildings and HVAC systems. It can also be used to retrofit existing buildings, and models convective, conductive and radiator heat transfer. FloVent also includes automatic solar loading boundary conditions and treatment for heat gains and losses through windows. It simulates turbulent or laminar airflow and provides contour animation so that the designer can visualize heat transfer pass and airflow representing airflow by vectors or ribbons with various colors indicating temperature or airflow speed. Similar packages are STAR-CCM+ and STAR-CD from CD-Adapco, ANSYS-FLUENT from Ansys, and Airpak from Fluent.

FloVent and similar computer aided design systems use what is referred to as the Navier-Stokes equation which describes the motion of fluid substances and is well known in the field of mechanical engineering and thermodynamics. These equations arise from applying Newton's second law to fluid motion together with the assumption that the fluid stress is a sum of the diffusing viscous term proportional the gradient of velocity and the pressure term. It is used to model air movement in the atmosphere such as the weather, ocean currents, water flow in a pipe, airflow around the wing, etc. These equations are a set of non-linear partial differential equations which model turbulence as well as regular airflow. They are used together with boundary conditions to model fluid motion. In the area of airflow and heating and cooling, the key elements of the equation are the temperature, conduction, source/sync of heating, convection and radiation.

Thus this is a part of the field of computational fluid dynamics (CFD). Such problems are frequently solved using a mathematical technique referred to as a finite element method or finite element analysis. This mathematical approach typically involves solving the problem for a mesh or grid in two or three or more dimensions. See, for instance, U.S. Pat. No. 4,912,664 Weiss et al. issued Mar. 27, 1990 and incorporated herein by reference directed to the mathematical approach of generating a mesh for finite element analysis and solving same using computer software. This mesh approach is typically well known for determining the physical characteristics of a hydraulic (fluid) system and modeling continuous physical characteristics such as temperature, pressure, and heat which are approximated by a discrete model composed of a set of piece-wise continuous functions defined over the mesh.

In more detail, finite element method (FEM) or finite element analysis (FEA) are numerical techniques for finding approximate solutions of partial differential equations of the Navier-Stokes type. The finite element method is especially useful over complicated domains such as fluid systems such as air movement in a building when the desired position varies over the entire domain. Thus one can have a denser mesh in certain portions of the system and a larger size mesh at other portions reducing the computer cost of simulation. It is well known to use FEM and FEA for thermal, magnetic, fluid and other systems. This method allows entire designs to be constructed, refined and optimized in a modeling format before the physical system is actually constructed. Of course, this is especially useful in the context of buildings and other complex systems. For instance, it is well known to use the finite element method to solve problems related to air movement within a building using turbulence modeling and other aspects of CFD.

However, the present inventor has identified deficiencies in these known systems (known as CFD thermal simulation tools) especially as relates to building design for HVAC. FloVent and similar systems only provide a single design per simulation iteration. They have no analytical way to optimize such designs. Instead they rely on either human expert input so the individual design outputs are somewhat optimized, or a “brute force” approach using many iterations, hence many designs, with a human expert selecting one quasi-optimized design. This process is computationally intensive (slow) since CFD must use a relatively fine mesh such as 1 cm³ volume elements and also requires substantial human expert input. For instance, it would require an experienced engineer about 40 or 50 hours to optimize the HVAC of a single family house.

### SUMMARY

In accordance with the invention, a computer-based method and system are provided typically embodied in computer software executed on a computer, e.g., a work station or other type. Conventional HVAC design tools as explained above are computationally very slow, since the underlying basic model in terms of the physics of air (fluid) flow is that of the Navier-Stokes equation and solutions are computed using CFD.

Instead a computationally much simpler (hence faster) approach is used here by initially modeling the building and its HVAC system (1) more coarsely in terms of the mesh of data points; (2) more simply as an analog electrical circuit. The data input to the present software tool includes not only the building design in terms of the size and layout of the rooms, including windows which allow solar radiation to enter and heat to leave, doors, the building location, local weather, building materials especially in terms of insulation value, and other factors that are well known aspects of building design. Also provided are boundary conditions such as the ambient temperature, etc.

The present method is directed towards designing the HVAC system for a new building or a retrofit of a building. In the examples given here this is a forced air circulation system. In other embodiments with suitable modifications the present system may be used for buildings using, for instance, radiant or circulating water or steam heating and/or cooling. The present inventors have determined that most present day HVAC systems are not well designed in the sense that they consume excess energy (1) to circulate the warm or cool air through the ducts and the rooms, (2) to warm or cool the air, and also do not necessarily provide good temperature control within the building in terms of heating or cooling. Thus typically most buildings, especially larger commercial type buildings, undesirably have hot and cold spots or use excessive energy. The design of the HVAC system includes the air ducts and their layout and size in terms of length and internal dimensions, and presence and location of dampers within the ducts. A damper is a structure within the duct which partially blocks air movement within the duct. They are typically introduced to direct the air in certain ways through the ducting system. Note that the typical ducting system includes not only the outgoing ducts which carry the warm and/or cool air from the air-conditioning or heating plant to the rooms, but also the air return ducts. Typically the return ducts are a separate set of ducts but also require design.

The present system, unlike FloVent and similar tools, provides an analytical (optimized) solution to HVAC design. It does this by initially constructing a high level (coarse grained) model of the building and its HVAC to find an optimal region (range) of solutions, using a mathematical neighborhood method. The model, rather than using CFD, models the building as an electrical circuit which is computationally much easier. Then given this region of solutions provided by the electrical circuit model, other conventional tools packages such as FloVent can then be used to define more detailed solutions within the optimal region. This advantageously limits use of FloVent to only a few iterations. Further, no expert is needed to find the optimal region since that is performed analytically by the system. It has been found this approach is about 500 to 1,000 times faster than the conventional approach.

The present system employs in one embodiment an electrical circuit model of the building in the form of a network of electrical R-C (resistance-capacitance) loops (circuits), each loop representing e.g. a room or suite or floor of the building. These loops are (by simulation) electrically coupled together to generate a model of the entire building. In each loop, the electrical resistance, capacitance, current and power respectively map to heat sources, room volume, air flow, and energy use. Such electrical networks are readily modeled using commercially available computer aided design software tools intended for analog electrical circuit design. Note that the analogy of an electrical R-C circuit to a building is rather close. Electrical resistors dissipate energy, electrical capacitors store energy, and electrical current moves in a loop through a circuit.

There are five elements of energy efficiency in buildings. They are source, component, distribution, monitoring and storage efficiencies. These efficiencies have to be solved and designed simultaneously. Heating, Ventilation and Air Conditioning (HVAC) systems are an integral part of distribution efficiency, as they account for about 55% of monthly energy bill for buildings. Traditionally, when designing for efficiency, HVAC engineers use only a mathematical approximation of the necessary flow parameters resulting in HVAC systems that are far less efficient than they could be. The present software simulates and optimizes the HVAC system of a building to a far greater degree of accuracy than traditional methods, and at a computational speed a thousand times faster than brute force methods for the same calculation. An optimized HVAC system in accordance with the invention is expected to reduce the temperature variation (gradient) across the building, thereby reducing energy consumption by about 35% for commercial and residential buildings.

Typically in an HVAC system the air is pushed and pulled through the ducts by ventilation fans. Operation of the fans uses substantial energy since they are electrically powered. It is desirable to optimize the amount of energy consumed by the fans in circulating the air through the ducts as well as the energy (electricity, gas, etc.) needed to heat and/or cool the air. Note that the present invention is not limited in terms of the source of the warm or cold air (or water or steam for a circulating steam or water system) since it is essentially directed to the duct or pipe design, rather than the air-conditioning or heating units. It is thus compatible with air (or water) heating and air cooling units of the types commercially available. One aspect in accordance with the invention is that the air ducts, in terms of their sizes, are designed so as to be most efficient in terms of not impeding airflow and, also providing smaller ducts where less volume of airflow is needed. Larger ducts cost more to install, hence minimizing duct size is also a goal here.

Note that the structure of the actual air ducts (or pipes in a system circulating steam or water) may be conventional. In most cases the ducts would be fabricated from conventional sheet metal structures and/or plastic tubing of the types commercially available. Thus the ducts and baffles provided in the ducts are intended to remove or reduce temperature gradients within any one room and across the building as needed in an efficient manner in terms of energy consumption.

### BRIEF DESCRIPTION OF THE DRAWINGS

FIG. 1 shows in a flowchart a method in accordance with the invention.

FIG. 2A shows inputs and outputs to the method of FIG. 1.

FIGS. 2B, 2C show exemplary electrical circuits simulated in the FIG. 1 method.

FIG. 3A shows graphically air temperatures in a room before design optimization; FIG. 3B shows temperatures in the room of FIG. 3A after optimization.

FIG. 4A shows air temperatures in a second type of room before optimization; FIG. 4B shows temperatures in the same room after the optimization.

FIG. 5A shows a ceiling duct design in the prior art; FIG. 5B shows the ceiling duct design for the building of FIG. 5A after optimization.

FIG. 6 shows air pressure distribution in air ducts after optimization with dampers.

FIG. 7 shows air velocity after duct optimization with dampers.

FIG. 8 shows velocity of air movement through air ducts after optimization.

FIG. 9 shows air pressure distribution in a duct system after optimization.

FIG. 10 shows velocity of air movement after duct optimization and damper addition.

FIG. 11 shows a conventional computer system.

### DETAILED DESCRIPTION

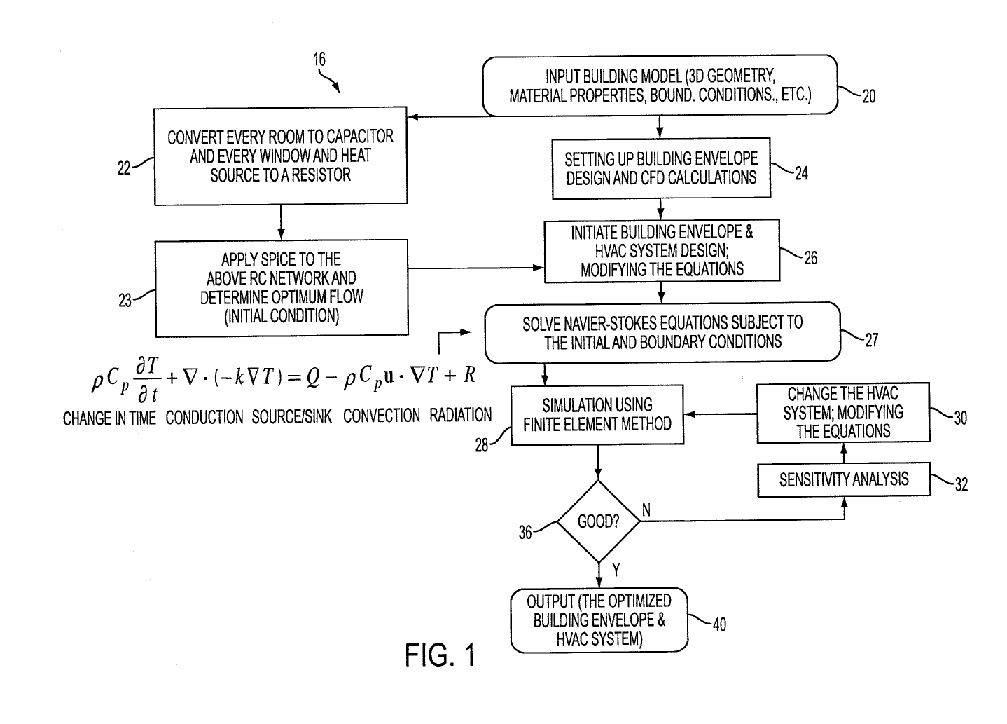

FIG. 1 shows in a flowchart a method 16 in accordance with the invention. This method and the associated system are typically embodied within a computer program (“computer software” or “computer code”) executed on a computer processor resident in a computer system of conventional type also including suitable storage (memory) and other components, see FIG. 12. The computer program may be coded in any convenient computer language such as C or C++ but that is merely exemplary. In embodiment it is coded in the Autodesk Revit or gbXML languages. Coding such software would be routine in light of this disclosure and the well known aspects of computational flow dynamics and the finite element method referred to above. The output from the computer program is in tabular form and/or a display showing graphically temperatures and airflow in an HVAC system as depicted in the figures referred to hereinafter. This output may also be in the form of a building design file suitable for the actual design of the HVAC air ducts and accompanying structures such as dampers, grilles, etc. Hence much of the implementation here uses routine aspects of computer aided design as well known in the building design field and so further detail is not provided in that regard. Method 16 depicted in FIG. 1 thus is also embodied in a computer system of conventional type having the elements shown in FIG. 12 and explained further below.

In the first step 20, one inputs a conventional building design data file which is in a standard computer aided design format such as DWG and DXF used in the Revit MEP suite from AutoCAD. The building design is in terms of room layout, walls, doors, windows, etc. for the particular building. It may include an initial design for the HVAC system also. In step 22 each room in the room layout is converted to an electrical capacitor equivalent and each window or other heat source (see below) to an electrical resistance equivalent. In step 23, a SPICE simulation (see below) is applied to the resulting Resistance-Capacitance (RC) electrical network of step 22, see below, which is solved for an optimization (see below). This simulation first maps relevant aspects of the building and its HVAC system to analogous aspects of an analog electrical circuit, then simulates (models) the circuit by well known techniques such as the SPICE software analog circuit simulation tool.

Next in step 24 the method sets up (establishes) the building envelope and HVAC system design from the building design file 20 and the conventional computational flow dynamic calculations. The set up step 24 includes setting conventional boundary and local conditions which include ambient factors such as sun angle, sun azimuth, solar irradiance, external ambient temperatures, wall and roof insulation, window insulation, internal heat loads from windows, people, appliances, computers, lighting, etc., and a target internal air temperature such as 21° C. (72° F.). Also most buildings have a minimum air flow requirement, expressed in cubic feet per minute or cubic meters per minute.

Next, in step 26, the method initiates the building envelope and HVAC system design using the building design file where the initial conditions are set by the SPICE optimization solution of step 23. The initiation step 26 assumes “natural” air flow and temperatures (no HVAC air flow). This means no HVAC provided for air flow or heating or cooling. This means closed windows, no air conditioning or heat, and the building heating or cooling due to radiation absorption, heat losses, and internal human and appliance and lighting, etc.

In step 28 the method executes a simulation of the building and its HVAC system. The well known Navier-Stokes equation of step 27 is shown algebraically in FIG. 1 and explained above. In one embodiment, in step 28 the Navier-Stokes equations of step 27 are solved as fourth order non-linear partial differential equations, with all the parameters being solved for simultaneously. Parameters such as temperature, humidity, buoyancy, and velocity in three dimensions are all functions of temperature where temperature is unknown. Therefore here all the parameters are solved simultaneously to satisfy the Navier-Stokes equation in step 28. Known tools only make first order approximations of fourth order non linear equations to solve the Navier-Stokes equation, for greatly reduced efficiency results in comparison. Also, generally such prior CFD simulations only include the ∇T (conduction) and Q (source/sink) elements of this equation while the present method advantageously may map to all elements.

Here, this equation is solved using the Finite Element method in step 28, subject to the initiation step 26 where the solution to step 23 is used as a starting point. In a simple case, the state variables for steps 27 and 28 are size and position of the ducts, the volume flow rate, air velocity in three dimensions, pressure in 3 dimensions, temperature gradient in three dimensions, humidity, buoyancy in three dimensions, air density, subject to components of the room such as the building envelope information, such as the insulative R (not the same as electrical resistance) values of the room envelope, dry wall between rooms, windows, and roof, and subject to storage capacity of the room such as the dimensions of the room and subject to boundary conditions or extreme weather conditions of building, and subject to source of cool air. When all the above variables are solved simultaneously, one has an optimum energy efficient distribution system.

In step 36 the method checks if the simulated design appears to be “good enough” (optimized) in terms of the HVAC system energy consumption. Note that step 36 typically involves a mathematical analysis as well as a visual analysis using the types of output shown in the figures discussed below and explained hereinafter. An exemplary test for “goodness” is the temperature gradient across the building being less than a predetermined value, e.g., 1° F.

If the solution at step 36 is deemed not good enough according to some predefined parameter such as the temperature gradient, the method cycles through the computer code loop including a sensitivity analysis 32 which means sensitivity to changes in (1) air flow (electrical current) and (2) air temperature. The operator then changes the HVAC system design (the air ducts size and layout in this example) thereby modifying an aspect of the HVAC system in step 30. Then the method repeats the simulation of step 28 and returns to the determination if the solution is “good enough” in step 36. Eventually it is determined after several iterations of the code loop involving steps 36, 32, 30 and 28 that the solution is “good enough” (sufficient or adequately optimized according to the parameters) and at this point the method maps the SPICE parameters back to the analogous building parameters, and outputs the resulting optimized building envelope design output file including the design file for the HVAC system at step 40.

This output file from step 40 is typically in one of the standard CAD architectural design formats well known for such files as explained above. This file then is used conventionally to actually design (or redesign) the HVAC system. Other software (not shown) which uses the output file from step 40 includes:
(1) A layout package which translates the result of optimization into diagrams, schematics and blue prints that building contractors would understand.
(2) A post layout simulation: double checks the design parameters against building structural limitations.
(3) A final tune package: for mechanical engineers who want to extra fine tune the design parameters.

Steps 22, 23 in more detail are carried out using the “SPICE” model (analog electrical circuit simulation) in the form of computer software which performs optimization for electrical circuit designs. The goal is to model the performance of the building and its HVAC system as a complex function (curve) expressed as an electrical circuit where the independent variables map to air temperature and air flow and the curve (the dependent variable) maps to total HVAC system energy consumption which is to be minimized. Typically the curve is of a complex shape, so the use of SPICE locates an optimization region or neighborhood. The narrowness of this region is an expression of the design (solution) being approximate, as is typical of simulations of complex systems. This solution region is then provided to step 26 to reduce the number of iterations of the subsequent CFD model optimization of steps 28 to 36.

In SPICE is a computer open source software (or an equivalent tool) used to design and simulate analog electrical circuitry such as in integrated circuits. SPICE stands for Simulation Program with Integrated Circuit Emphasis. It is a general purpose analog electronic circuit simulator which uses a text net list describing the circuit elements in terms of transistors, resistances, capacitors, etc., and their electrical connections (conductors) expressed as a set of nodes and translates the simulation into equations to be solved based on Kirchoff's laws. The equations produced are non-linear differential algebraic equations. In accordance with the invention SPICE is adapted to model a building and its HVAC system. The present inventor has recognized that similar to a circuit, relevant aspects of a building and its HVAC system can be expressed as a set of coupled nodes, see further description below. Advantages of use of SPICE or a similar tool are that it is commercially available and open source, and so does not require coding of all the necessary equations. Other similar packages may be used instead of SPICE for steps 22, 23.

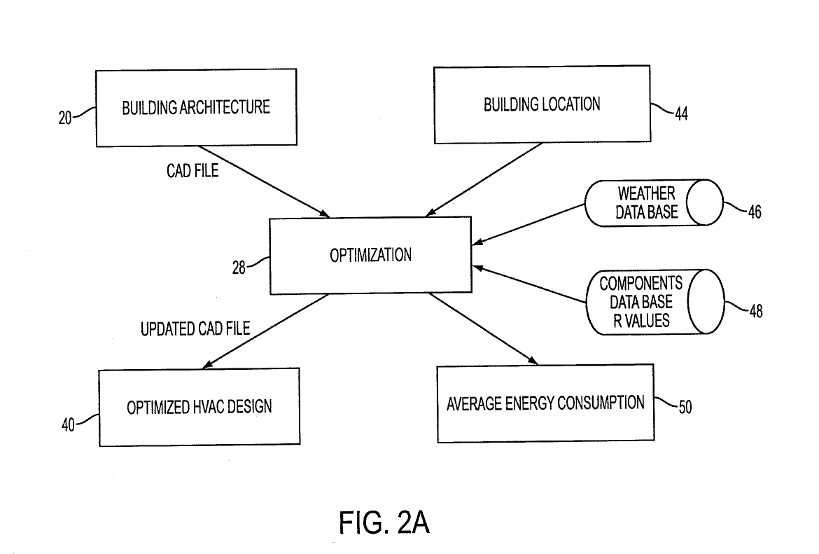

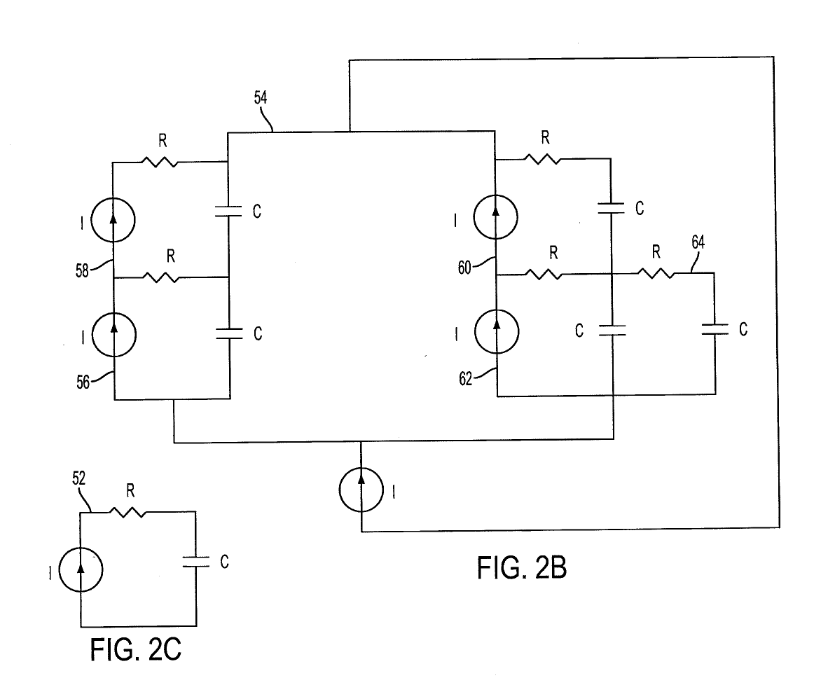

FIG. 2A shows in greater detail the data file inputs and outputs to the optimization step 28. In addition to the building architecture data file 20 of FIG. 1, data inputs may include the building location data file 44, database 46 of the local weather including typical high and low temperatures on a daily basis and/or an annual basis, etc., to determine total building heating and cooling needs, and conventional building components database 48, typically including the well known “R” values (not referring to electrical resistance) indicating the insulative value of various elements of the building as defined by building architecture file 20. Google Maps enables the system to readily obtain the orientation, and building situation with respect to neighboring buildings. One can also find the azimuth angle of the sun and extreme weather conditions from the zip code address of the building. The resulting output files from optimization 28 are file 40, explained above with reference to FIG. 1, and average energy consumption data file 50 which provides an estimate of how much energy the building will typically consume under various conditions and allows determination of how much heating and/or cooling capacity is needed.

Depending on the amount of computational power needed, which is dependent on the size and complexity of the building and the fineness of the mesh (or meshes) both expressed as electrical circuit nodes used in the simulation, a typical personal computer may not provide sufficient processing power. That is, the process shown in FIG. 1 may take an excessive amount of time to execute on a personal computer. In that case additional computer power may be needed such as a more powerful computer such as a workstation or mainframe or a set of networked computers. One way to do this is to employ so-called cloud computing using additional computer power supplied by other computers coupled via the Internet. Such an approach is well known for computationally intensive problems.

In further detail, with regard to FIG. 1 in step 26 the system may, for instance, store solutions of previous similar problems in a database and use them to arrive at a better initial estimate for the current design. The more sophisticated and better the initial design the fewer iterations of steps 28, 36, 32 and 30 are needed to arrive at an optimized design. Further in step 28 the system or the operator may select larger mesh sizes in early iterations or unstructured meshes or adaptive type meshes to speed computation. Further, the system may use multi-threaded software code and a hardware accelerator and other types of well known computing techniques to improve the speed of the simulation 28.

In terms of using SPICE to simulate the HVAC system of a building, this approach in one embodiment models aspects of the building and its HVAC system as a plurality of electrically coupled R-C circuits. First one maps (assigns) the volume (expressed in cubic feet or cubic meters) of each relevant unit (room, suite, or floor) or other portion of the building to electrical capacitance C, e.g. a capacitor, having a particular capacitance expressed e.g. in farads or micro-farads. The relevant building unit is a room, a suite of rooms, or a floor of the building. The heat sources (people, appliances, lighting, computers, machinery, solar irradiance through windows, etc.) which are in watts in each unit map to an electrical resistance, e.g. a resistor, having a resistance R expressed in ohms. These heat sources in each unit of the building are considered to be additive, hence series connected. See FIG. 2B showing schematically such a simple R-C circuit 52. Electrical alternatives to the R-C circuit simulation can be sued, such as inductance-admittance circuits (L-Y).

The air flow required in each building unit, expressed in units of cubic feet or meters per second, maps to electrical current in the form of a current source outputting an electrical current expressed in amperes. So each room or suite or floor of the building maps to an R-C circuit (loop) including a current source, resistors, and capacitors of the type readily modeled by SPICE or similar simulators. Notably, the electric power (calculated conventionally as I²R where I is current and R is resistance) consumed by such a circuit maps to the HVAC system energy consumption of the room.

So such a model circuit 52 is specified for each room (or suite or floor). The various rooms (or suites or floors) of the entire building are then in the model coupled together by mapping their HVAC connections (including the air ducts and building hallways, etc.) to electrical connections of the various R-C loops. Typically the adjacent circuit loops (rooms) are modeled as being electrically coupled across a shared resistance or capacitance, depending on whether the adjacent RC loops are connected in series or in parallel. The series/parallel connection corresponds to the equivalent air duct arrangement for the HVAC system.

This is shown in FIG. 2C, where an entire building is modeled as a complex R-C circuit 54 shown schematically, which is readily modeled by SPICE. Circuit 54 includes R-C loops 56, 58, 60, 62, 64 each representing one room. SPICE then allows one to redesign the circuit (within specified parameters) to minimize total electrical power consumption, mapping to minimum HVAC energy consumption. In practical terms this SPICE modeling, as described above, arrives at not so much an exact optimum solution (the power consumption minimum) but at a neighborhood of the power (energy) curve in the region around the optimum solution. This neighborhood is, e.g., within 5% of the actual optimum. From that point, special purpose simulations such s FloVent may be used to (1) arrive at one optimized solution, and (2) do the more detailed HVAC system design as explained above. Note that the present approach reduces computation time by a factor of 200 to 500 versus using FloVent or an equivalent tool exclusively. This minimization of energy (power) consumption is calculated as I²*R conventionally, where I is current and R resistance. The time frame over which to minimize power consumption is any convenient period, such as an hour, day, month, and year.

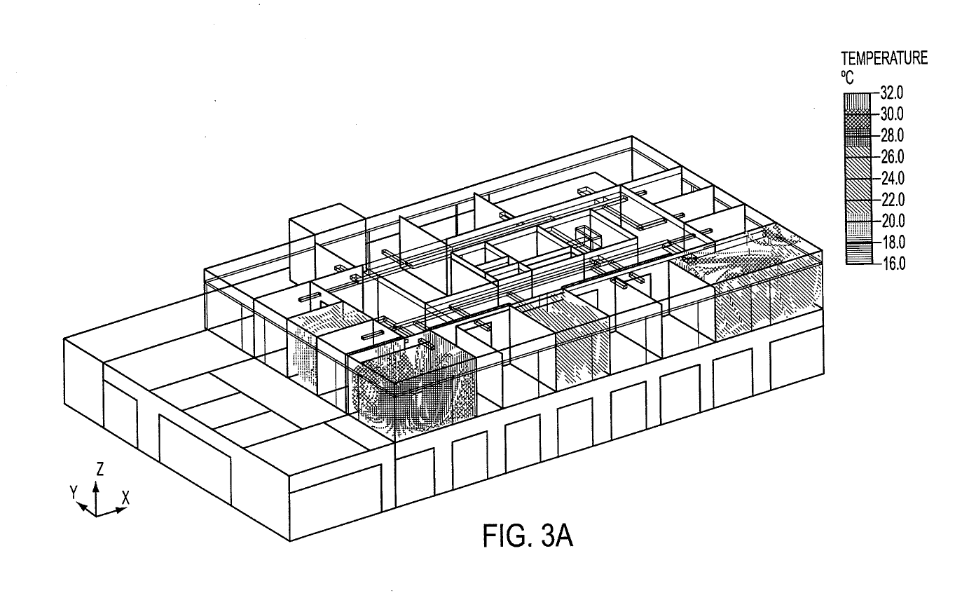

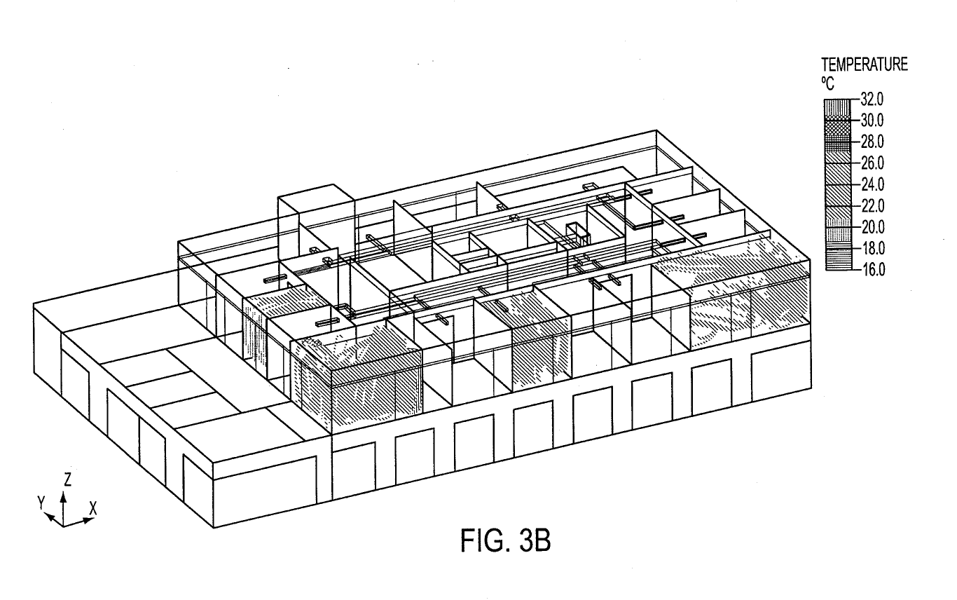

FIG. 3A is a conventional computer generated graphic depiction of air circulation in a set of rooms in a building shown in a perspective view and as provided also in accordance with the invention. The walls between rooms are depicted as well as the outer wall of the building. Only certain rooms have their air circulation depicted which are the rooms in the lower right hand corner, the lower left hand corner, the middle and the front, and one near the upper left hand corner. The various swirling lines indicate the temperatures in the rooms according to the scale shown on the right hand side of FIG. 3A. Normally these are color coded but here they are depicted in shades of gray. In this case, as can be seen by the different shadings, the rooms have substantially different temperatures whereas the room at the lower left is at high temperature, approximately 32° C., and the room at the lower right is at a much lower temperature, approximately 24° C. The room in the middle and the front is even lower temperature, approximately 20° C. In contrast, the room at the upper left is closer to about 16° C., thus there is approximately 15° C. temperature difference between the various rooms. (Note the X, Y, Z axes depicted in the lower left for purposes of reference.) This is a typical example of a poorly designed air circulation system which is also likely wasteful in terms of energy consumption due to the hot and cold spots but is not unusual in conventionally designed buildings.

In contrast, FIG. 3B depicts the same structure after the present method has been applied to redesign the HVAC air ducts. In FIG. 3B there is only approximately a 1 degree temperature gradient between the rooms, hence all the depicted rooms have approximately the same temperature around 22 degrees C. equal to approximately 72 degrees F. This is an optimized HVAC design.

Moreover, the present approach results in a design more efficient in terms of energy consumption. In one design of a multistory building using the present approach it was found that while cooling the building (in summer, in a sunny climate) a conventional HVAC design resulted in an air flow in each suite of 2,500 CFM and an air temperature as output by the central air conditioning units of 55° F. to achieve room temperatures of 72° F. In contrast, the present method required an air conditioning unit output air temperature of 61° F. but higher (e.g., 3,500 CFM) air flow. Overall, at typical costs of electricity, this would reduce HVAC energy costs by over 30%. One insight in accordance with the invention is that the energy cost of moving air through an HVAC system is less than the energy cost of cooling air. So a given target air temperature can be achieved with less cooling and more air flow with lessened energy consumption.

In one embodiment, the output file 40 allows calculation of operational (energy) expense vs. capital (construction) expense saving, plus duct optimization and distribution energy efficiency with respect to the above described five efficiencies. Specifically, the system illustrates the flow parameters to HVAC engineers who want to design optimum (e.g., “Net Zero”) energy buildings. For example, this is the dollar amount of energy savings per year versus the dollar amount of extra construction expenses per state variable involved in optimization. Based on the output, the building owner or the contractor can decide which state variable he wants to enforce or employ in the construction. Building owners tend to employ the state variable that pays for itself (in energy savings) in less than ten years. For permits incorporate solar panels as one of the state variables, and would give the customer at least fifteen other state variables that could save an equal amount of energy as compared to solar panels, at much less cost than solar panels.

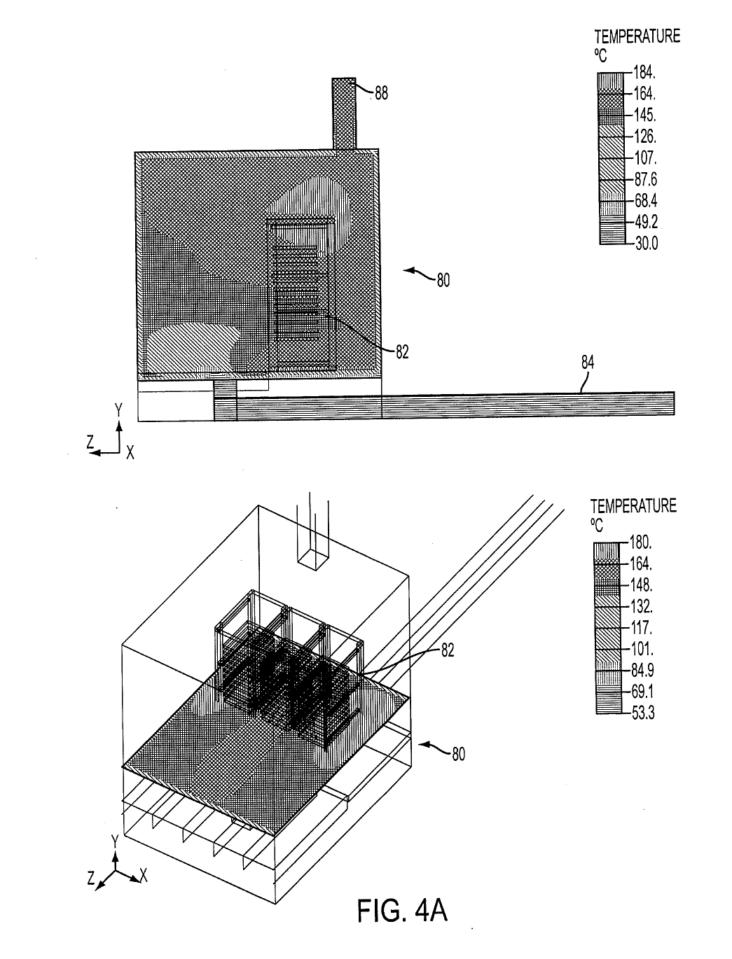

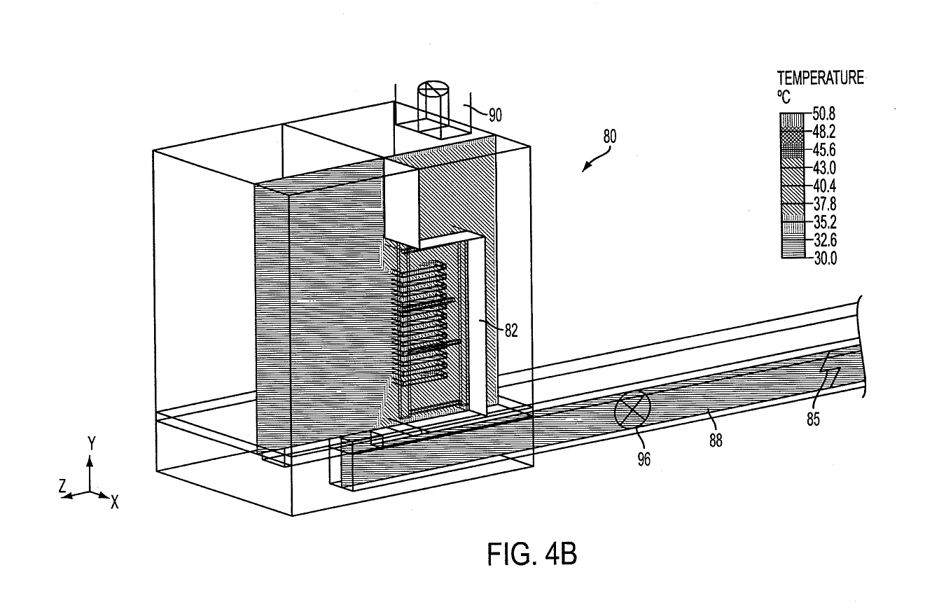

In another set of similar graphic depictions, FIG. 4A depicts in its upper portion a plan view of a single room 80 in a building containing a set (“stack”) of computer servers 82 which are notorious sources of heat in an office building. This simulation assumes the servers 82 in the room dissipate 18 KW of electric power which of course becomes 18 KW of heat. In this case, the server stack 82 is located on the right where the shading is darkest and exhibits a local temperature of 174° C. as indicated. A few feet away from the server stack 82 the air temperature is considerably lower (157° C.) although still quite hot. The supply air duct 84 is shown as the rectangular structure (the air inlet) at the bottom portion of the drawing showing an air temperature of approximately 30° C. In contrast, the air in the return air duct 88 at the upper portion of the drawing is at 168° C. This room 80 is further shown in a perspective view in the lower portion of FIG. 4A, again showing the highest temperature at the upper right hand portion of the room.

FIG. 4B shows in contrast the same room 80 after the air ducting design has been optimized in accordance with the invention including a suitable damper 85. As can be seen, the air temperatures are at maximum of approximately 40° C., and just adjacent the server stack 82 only about 30° C. This design further includes the inclusion of an exhaust fan 96 mounted in the return air duct 90 and a second supply fan 98 mounted in the supply air duct 88. Such fans 90, 96 are of commercially available type, and here they are mounted within the air ducts remote from the HVAC air conditioning unit. This promotes air flow and allows efficient provision of high rates of air flow. Such fans may be provided where needed throughout the ducting, their location being determined as part of the HVAC system and capacity design step 26. If there is more than one such fan in any one duct or stretch of ducting, they should be in phase to reduce static pressure. Such remote or distributed fans mounted in the air ducts are also called booster fans or in-line duct fans in the construction industry.

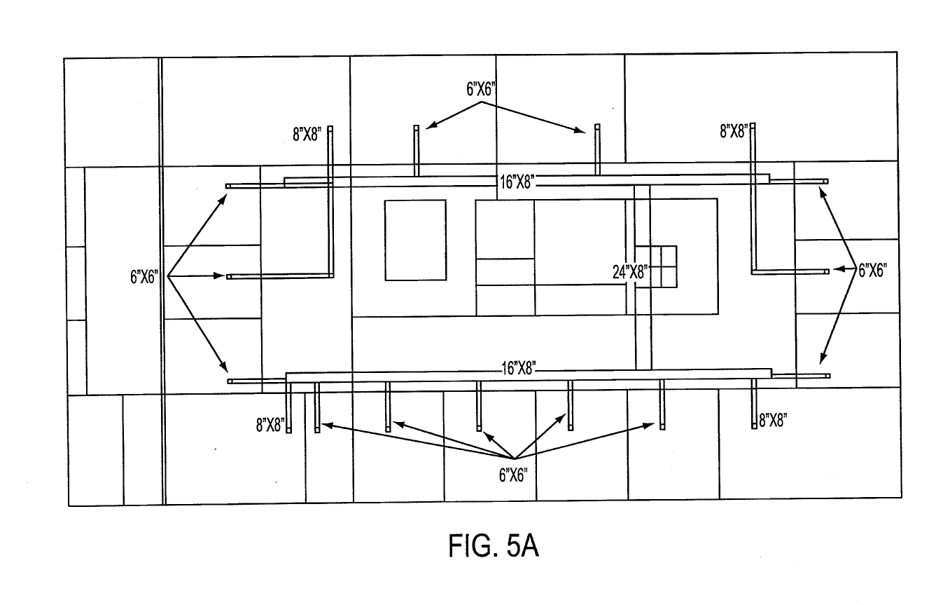

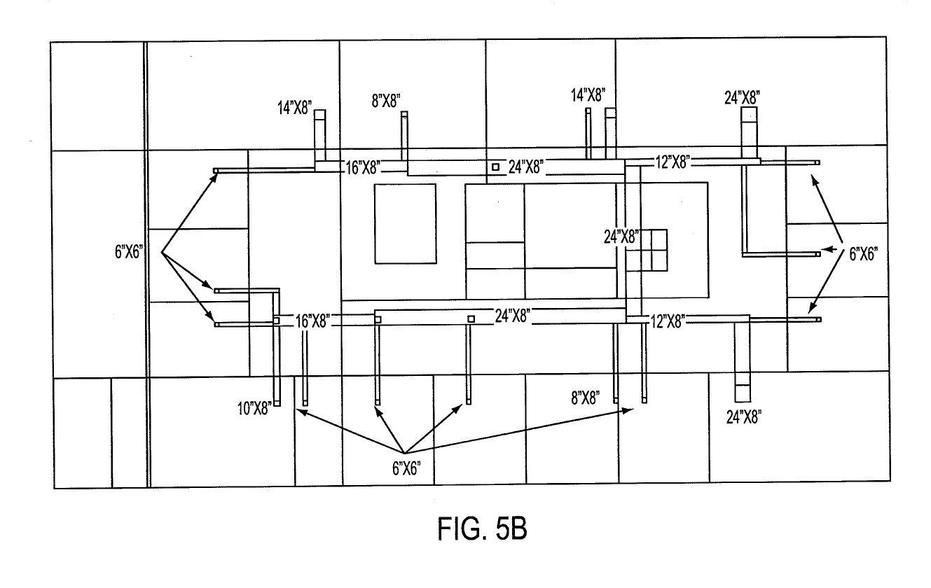

FIG. 5A shows in a plan view a building ducting system as conventionally designed and also shows the building interior walls. Note that these ducts are conventionally typically present in the ceilings and/or walls. In most commercial buildings they are in the ceilings exclusively, but this is not necessarily the case for residential buildings. However, that is a design choice and not central to the present method. As seen here each duct has characteristic internal dimensions (cross section) expressed here in inches in terms of the width and height of each duct. Some of the large ducts here are 24″×8″ (61×20 cm) while the smaller ones are 6″×6″ (15×15 cm). The size of the ducts is conventionally typically determined by an engineer's judgment or in some cases by relatively simple computer simulations.

In contrast, FIG. 5B shows a similar ducting system but optimized in accordance with the invention. The total length of ducting is approximately the same and the average internal dimensions of the ducts are not significantly different. However, the duct (internal) sizing is distributed differently so as to optimize airflow and thus minimize the amount of energy needed to power the circulation fans. Hence the actual cost of the ducting and its installation will be approximately the same as in the FIG. 5A case, but the efficiency of air distribution is substantially enhanced thereby reducing energy use.

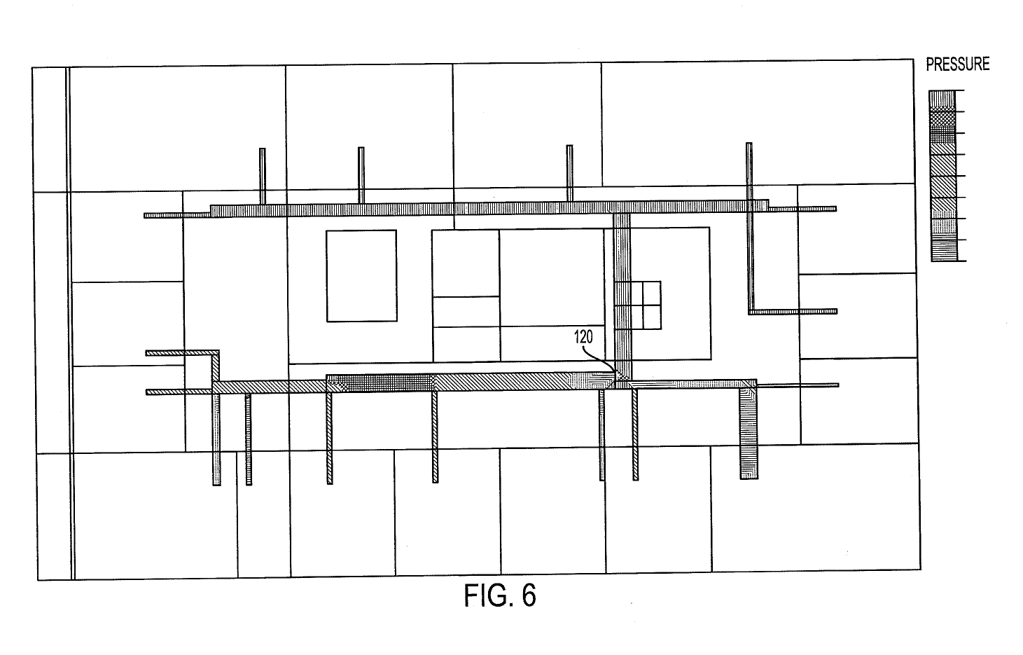

FIG. 6 shows the system of FIG. 5B with the relative air pressures in the ducts shown according to the scale on the right hand side with air pressure expressed here in terms of inches of water. Also provided here is a damper located at the junction 120 of several of the ducts and causing the illustrated air pressure differentials

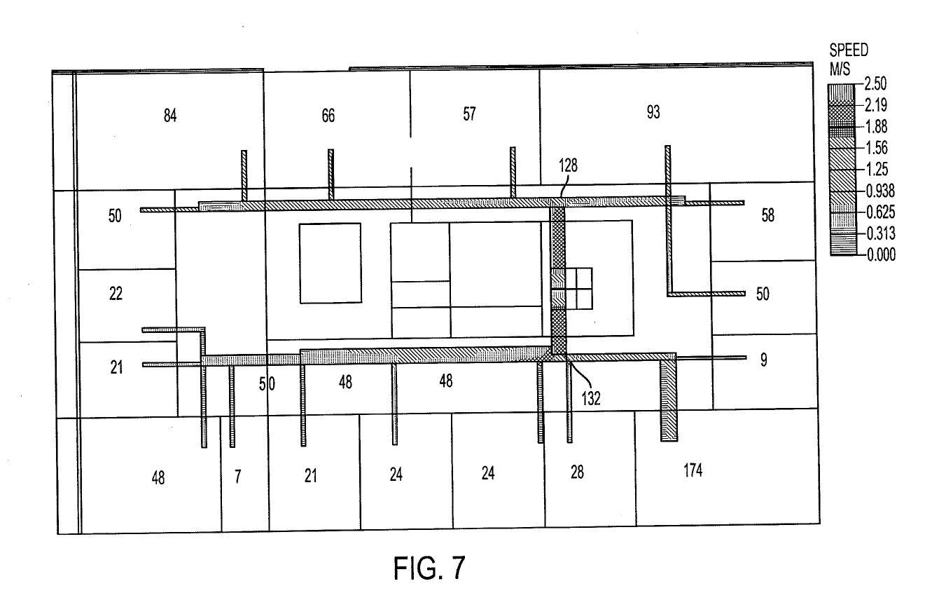

FIG. 7 shows a duct system designed with duct optimization and the presence of dampers at locations 128 and 132. The numbers in the figure indicate the airflow in cubic feet per minute from each duct outlet as indicated at the end of each duct. As seen, airflow varies between 7 and 93 cubic feet per minute depending, of course, on the amount of circulation needed for any particular room. Moreover, the speed of the air through the ducts is shown according to the scale on the right hand side of FIG. 7.

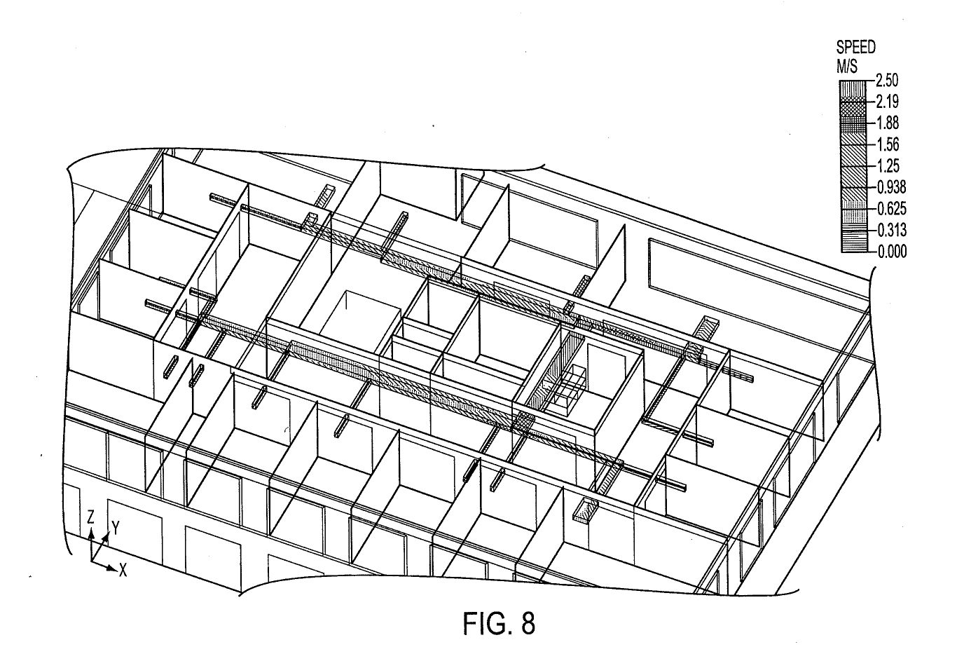

FIG. 8 shows in a perspective view a depiction of a building with optimized ducts and shows the velocity of the air through the ducts shown according to the scale on the right hand side and is otherwise similar to FIG. 7.

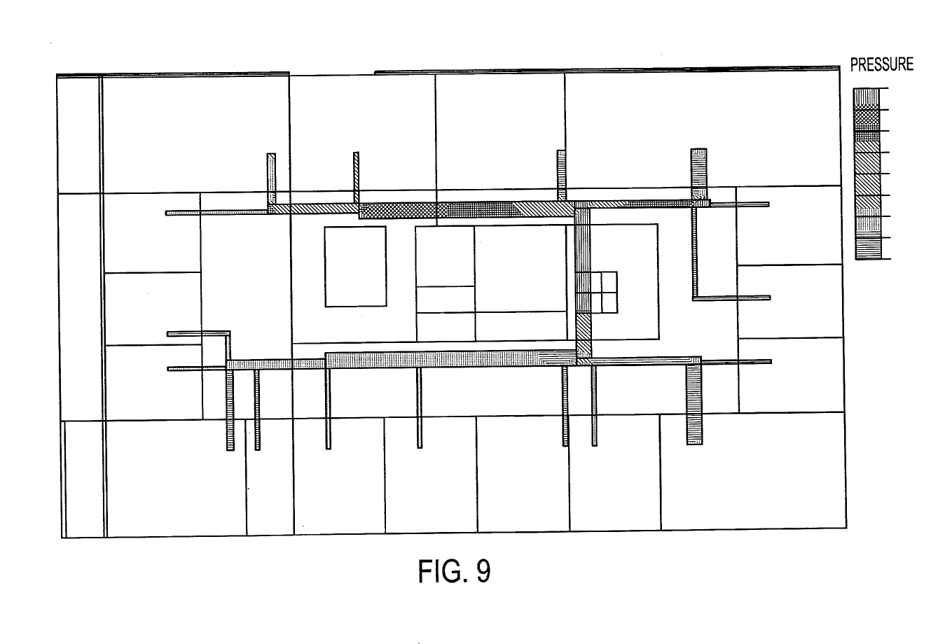

FIG. 9 shows for a ducting system similar to that of, for instance, FIG. 7 the pressure in terms of inches of water at various points in the duct according to the scale.

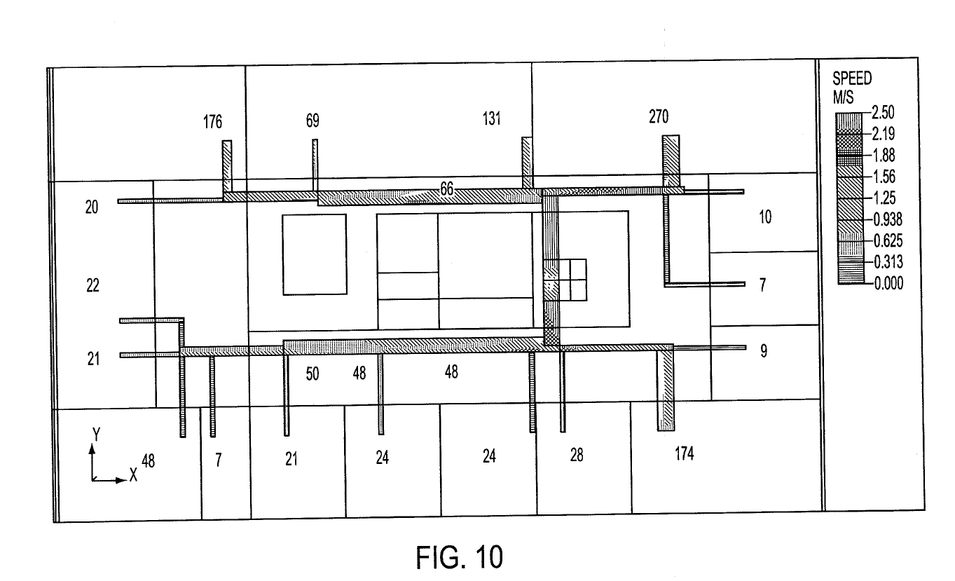

FIG. 10 shows a similar system as FIG. 7 showing the speed in terms of the airflow depictions according to the scale on the right hand side and the amount of airflow in terms of cubic feet per minute at the end of each length of duct.

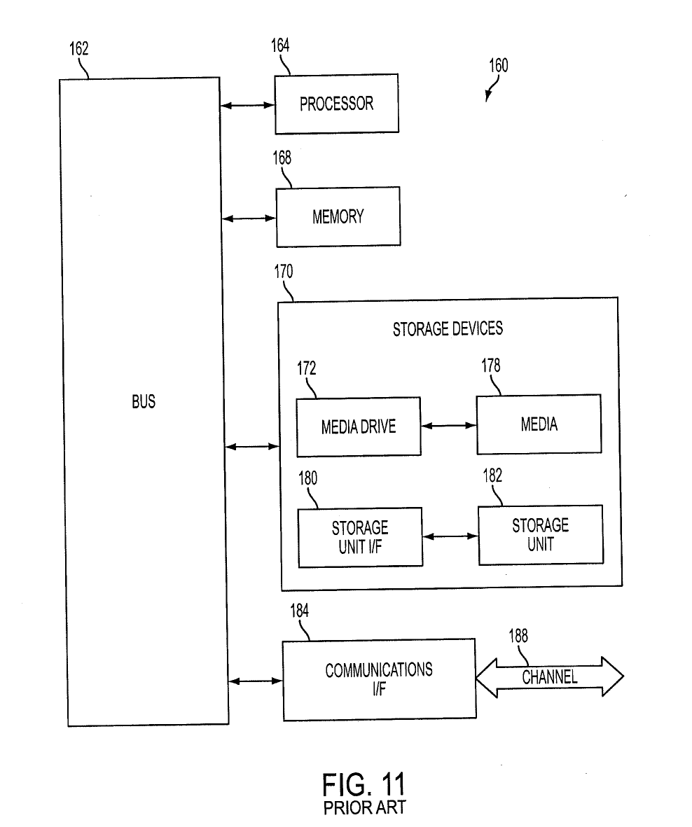

FIG. 11 illustrates a typical and conventional computing system 160 that may be employed to implement the processing functionality in embodiments of the invention. Computing systems of this type may be used in a computer server or other computing device, for example. Those skilled in the relevant art will also recognize how to implement embodiments of the invention using other computer systems or architectures. Computing system 160 may represent, for example, a desktop, laptop or notebook computer, mainframe, server, or any other type of special or general purpose computing device as may be desirable or appropriate for a given application or environment. Computing system 160 can include one or more processors, such as a processor 164. Processor 164 can be implemented using a general or special purpose processing engine such as, for example, a microprocessor, microcontroller or other control logic. In this example, processor 164 is connected to a bus 162 or other communications medium.

Computing system 160 can also include a main memory 168, such as random access memory (RAM) or other dynamic memory, for storing information and instructions to be executed by processor 164. Main memory 168 also may be used for storing temporary variables or other intermediate information during execution of instructions to be executed by processor 164. Computing system 160 may likewise include a read only memory (ROM) or other static storage device coupled to bus 162 for storing static information and instructions for processor 164.

Computing system 160 may also include information storage system 170, which may include, for example, a media drive 162 and a removable storage interface 180. The media drive 172 may include a drive or other mechanism to support fixed or removable storage media, such as flash memory, a hard disk drive, a floppy disk drive, a magnetic tape drive, an optical disk drive, a compact disk (CD) or digital versatile disk (DVD) drive (R or RW), or other removable or fixed media drive. Storage media 178 may include, for example, a hard disk, floppy disk, magnetic tape, optical disk, CD or DVD, or other fixed or removable medium that is read by and written to by media drive 172. As these examples illustrate, the storage media 178 may include a computer-readable storage medium having stored therein particular computer software or data.

In alternative embodiments, information storage system 170 may include other similar components for allowing computer programs or other instructions or data to be loaded into computing system 160. Such components may include, for example, a removable storage unit 182 and an interface 180, such as a program cartridge and cartridge interface, a removable memory (for example, a flash memory or other removable memory module) and memory slot, and other removable storage units 182 and interfaces 180 that allow software and data to be transferred from the removable storage unit 178 to computing system 160.

Computing system 160 can also include a communications interface 184. Communications interface 184 can be used to allow software and data to be transferred between computing system 160 and external devices. Examples of communications interface 184 can include a modem, a network interface (such as an Ethernet or other network interface card (NIC)), a communications port (such as for example, a USB port), a PCMCIA slot and card, etc. Software and data transferred via communications interface 184 are in the form of signals which can be electronic, electromagnetic, optical or other signals capable of being received by communications interface 184. These signals are provided to communications interface 184 via a channel 188. This channel 188 may carry signals and may be implemented using a wireless medium, wire or cable, fiber optics, or other communications medium. Some examples of a channel include a phone line, a cellular phone link, an RF link, a network interface, a local or wide area network, and other communications channels.

In this disclosure, the terms “computer program product,” “computer-readable medium” and the like may be used generally to refer to media such as, for example, memory 168, storage device 178, or storage unit 182. These and other forms of computer-readable media may store one or more instructions for use by processor 164, to cause the processor to perform specified operations. Such instructions, generally referred to as software or computer program code (which may be grouped in the form of computer programs or other groupings), when executed, enable the computing system 160 to perform functions of embodiments of the invention. Note that the code may directly cause the processor to perform specified operations, be compiled to do so, and/or be combined with other software, hardware, and/or firmware elements (e.g., libraries for performing standard functions) to do so.

In an embodiment implemented using software, the software may be stored in a computer-readable medium and loaded into computing system 160 using, for example, removable storage drive 174, drive 172 or communications interface 184. The control logic (in this example, software instructions or computer program code), when executed by the processor 164, causes the processor 164 to perform the functions of embodiments of the invention as described herein.

This disclosure is illustrative but not limiting; further modifications and improvements will be apparent to those skilled in the art in light of this disclosure, and are intended to fall within the scope of the appended claims.

What is claimed:

1. A computer based method for design or simulation of a heating and ventilation system for a building, comprising the acts of:
setting a plurality of boundary conditions for the system and the associated building and storing the boundary conditions in a first computer readable memory;
partitioning the building into a plurality of units at a processor;
setting an initial design for the system and storing the initial design in a second computer readable memory;
for each unit, determining a heat load and a volume;
simulating temperature and air flow for each unit in the processor using the heat load, volume, and initial system design by modeling the unit as an electrical circuit;
combining the model for each unit into one model of the plurality of units;
optimizing the system design to minimize energy consumption of the electrical circuit; and
storing the optimized system design in a third computer readable memory.

2. The method of claim 1, wherein each unit is a room, suite, apartment, or floor of the building.

3. The method of claim 1, wherein the heat load is modeled as electrical resistance, the volume as electrical capacitance, the air flow as electrical current, and energy consumption as electrical power consumption of the circuit.

4. The method of claim 3, wherein the system is modeled as a plurality of electrical circuits coupled in series or parallel.

5. The method of claim 3, wherein each electrical circuit is modeled as an R-C circuit.

6. The method of claim 1, wherein the boundary conditions for the system include a minimum air flow and interior temperature.

7. The method of claim 1, wherein the boundary conditions for the building include at least one of outside temperature, window locations, wall insulation, roof insulation, solar radiation, and window insulation.

8. The method of claim 7, further comprising providing the boundary conditions for the building in a predetermined computer aided design format.

9. The method of claim 1, wherein the acts of simulating, combining and optimizing use a computer aide design electrical circuit simulator.

10. The method of claim 1, wherein in the optimized design the flow differs from unit to unit of the building.

11. The method of claim 1, wherein the act of optimizing optimizes for energy consumption for circulating a working fluid and heating or cooling the fluid.

12. The method of claim 1, further comprising the act of applying the optimized design to a computer aided design building heating and cooling tool using computational fluid dynamics to provide a detailed system design.

13. The method of claim 12, wherein the initial and detailed system designs each include interior dimensions of a plurality of air ducts, location of dampers in the air ducts, location of outlets into the units from the air ducts, and a temperature of air supplied to the air ducts.

14. The method of claim 12, wherein the act of using computational fluid dynamics includes performing a sensitivity analysis for the flow or temperature.

15. The method of claim 12, wherein the initial design and detailed design each include the air ducts for supplying and exhausting air for each unit.

16. The method of claim 12, wherein the detailed system design includes a plurality of fans mounted in the air ducts.

17. The method of claim 1, further comprising the acts of:
applying the optimized design to a computer aided design building heating and cooling tool using computational fluid dynamics;
repeating the act of applying until attaining an optimized solution using the tool; and
arriving at a detailed system design from the optimized solution.

18. A non-transitory computer readable medium storing computer code for performing the method of claim 1.

19. A computing apparatus programmed to carry out the method of claim 1.

20. Apparatus for design or simulation of a heating and ventilation system for a building, comprising:
a first computer readable memory which is adapted to store a plurality of boundary conditions for the system and the associated building;
a processor coupled to the first computer readable memory and which partitions the building into a plurality of units;
a second computer readable memory coupled to the processor and adapted to store an initial design for the system and the initial design;
the processor for each unit determining a heat load and a volume; and simulating temperature and air flow for each unit using the heat load, volume, and initial design by modeling the unit as an electrical circuit;
the processor combining the model for each unit into one model of a plurality of the units and optimizing the system to minimize energy consumption; and
a third computer readable memory coupled to the process and adapted to store the optimized design of the system.
